(19) United States
(12) Patent Application Publication
(10) Pub. No.: US 2025/0024240 A1
(43) Pub. Date: Jan. 16, 2025

(54) SELECTION OF EMERGENCY NUMBERS BASED ON EMERGENCY TEST PARAMETER

(71) Applicant: T-Mobile USA, Inc., Bellevue, WA (US)

(72) Inventors: Kunal Prakash Barawkar, Bothell, WA (US); Boris Antsev, Bothell, WA (US)

(21) Appl. No.: 18/350,485

(22) Filed: Jul. 11, 2023

(51) Int. Cl. H04W 4/90

(52) U.S. Cl. CPC H04W 4/90

(57) ABSTRACT

A core network node described herein is configured to receive an emergency test parameter for a user equipment (UE) during a message exchange for the UE. The core network node may then select from multiple, alternative extended emergency number lists an extended emergency number list for the UE based on the emergency test parameter and provide the extended emergency number list to the UE in an accept message.

### BACKGROUND

Effective dissemination of emergency numbers to user equipment (UE), such as mobile devices, is both a business and regulatory concern. Many governments have strict and detailed requirements for emergency calling capabilities that telecommunications network operators must meet. Recently, the Third Generation Partnership Project (3GPP), an important standards-setting organization, expanded the means through which emergency numbers could be provided to UEs. While previously a small, static list of emergency numbers was sent, the 3GPP specified the addition of an information element (IE) to accept messages in certain message exchanges between UEs and core network nodes, such as attach message exchanges and tracking area updates (TAUs) in Fourth Generation (4G) networks and registration message exchanges in Fifth Generation (5G) networks. This allowed specification of a greater range or emergency numbers, but telecommunications network operators were still limited to a same list for all UEs. Some UEs, however, such as tester UEs, need both the same emergency numbers as non-tester UEs as well as emergency numbers specifically for testing.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram of an example telecommunications network, including a telecommunications core network, and a UE communicating with that telecommunications network, receiving emergency numbers as part of a message exchange.

FIG. 2 is a message diagram of a message exchange between a UE and a core network node in which the UE receives an extended emergency number list in an accept response, the extended emergency number list selected for the UE by the core network node based on an emergency test parameter associated with the UE.

FIG. 3 is a schematic diagram of an example system architecture of a core network node that is configured to select an extended emergency number list for a UE based on an emergency test parameter associated with the UE.

FIG. 4 is a flow diagram of an illustrative process for selecting an extended emergency number list for a UE based on an emergency test parameter associated with the UE.

### DETAILED DESCRIPTION

This disclosure is directed in part to a core network node configured to select from multiple, alternative extended emergency number lists an extended emergency number list for a UE based on an emergency test parameter associated with the UE. The core network node belongs to a telecommunications core network and receives the emergency test parameter during a message exchange for the UE. After list selection, the core network node provides the extended emergency number list to the UE in an accept message.

In various implementations, the UE may be a tester UE and the extended emergency number list may include both a tester uniform resource name (URN) and a URN used for non-test emergencies by both tester UEs and non-tester UEs. In such circumstances, the tester UE may be able to make both test emergency calls and actual/non-test emergency calls and non-tester UEs need not received an extended emergency number list with tester URNs.

In some implementations, the core network node may provide both an emergency number list with statically defined URNs and the extended emergency number list to the UE. Such statically defined URNs may be used by UEs that are unable to process the extended emergency number list.

In various implementations, the core network node may be a mobility management entity (MME) or an access and mobility management function (AMF). The core network node may receive the emergency test parameter from a subscriber database, and the subscriber database may be a home subscriber server (HSS) or a unified data management (UDM) node. Further, in some examples, the emergency test parameter may be a zone code or an area identifier. Also, in various examples, the extended emergency number list may be provided in an information element of an accept message of the message exchange.

Also, the multiple, alternative extended emergency number lists may include the extended emergency number list and an alternate extended emergency number list. The alternate extended emergency number list in turn may include a subset of the URNs in the extended emergency number list or different URNs than the URNs in the extended emergency number list.

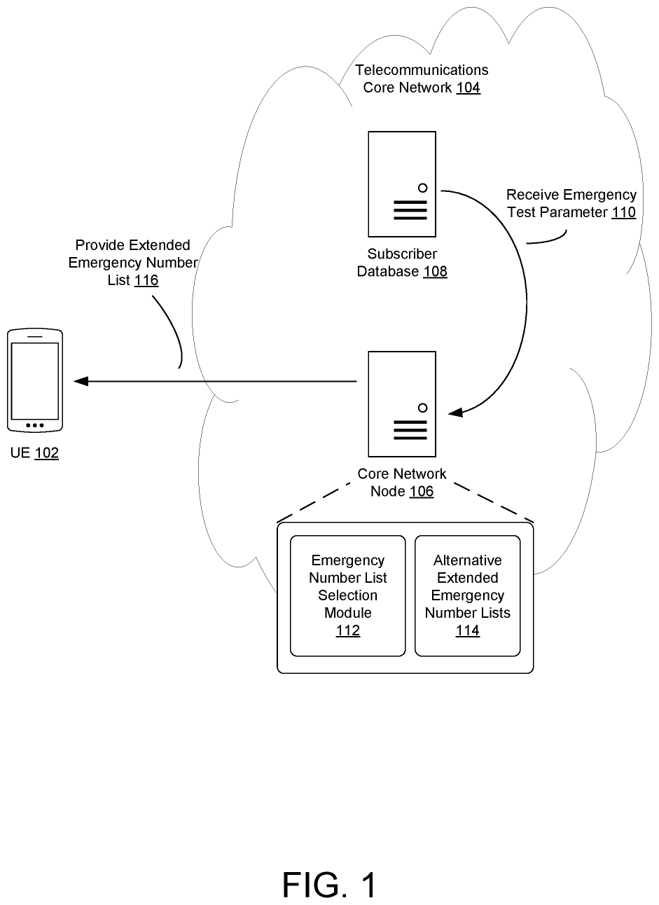

FIG. 1 is a diagram of an example telecommunications network, including a telecommunications core network, and a UE communicating with that telecommunications network, receiving emergency numbers as part of a message exchange. As illustrated, a UE 102 connects to a telecommunications network, including a telecommunications core network 104, through an access network (not shown). The telecommunications core network 104 includes multiple nodes providing services to the UE 102, including both a core network node 106 and a subscriber database 108. During message exchange between the telecommunications core network 104 and UE 102 (such as, e.g., an attach, TAU, or registration message exchange), the core network node 106 receives, at 110, an emergency test parameter from the subscriber database. Based on that emergency test parameter, an emergency number list selection module 112 of the core network node 106 selects between alternative extended emergency number lists 114. The core network node 106 then provides, at 116, the selected one of the alternative extended emergency number lists to the UE 102 in an accept message (e.g., an attach accept message, a TAU accept message, a registration accept message, etc.).

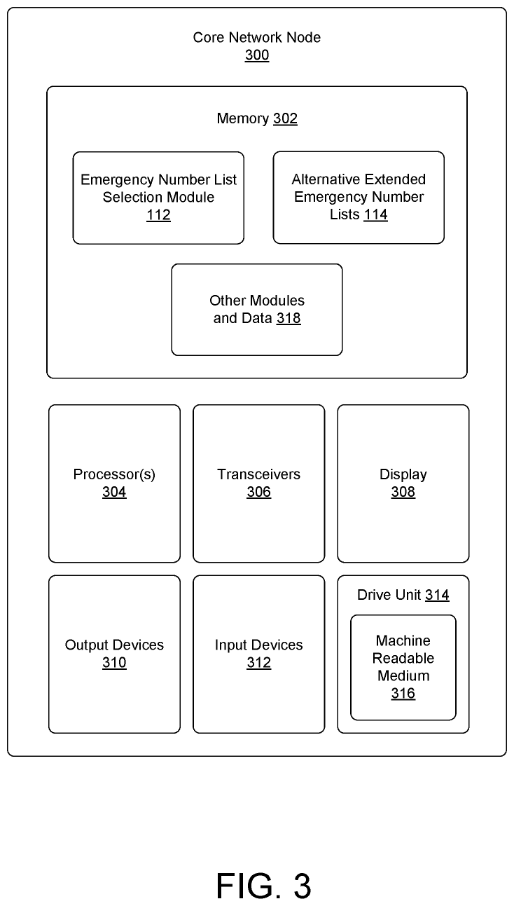

In various implementations, the UE 102 may be any sort of wireless communication device. The UE 102 may be a mobile device, such as a cell phone, a watch, goggles, glasses, an Internet-of-Things (IoT) device, a tablet computer, a laptop computer, a personal computer (PC), or any sort of computing device capable of mobility and wireless communication. An example architecture for a UE 102 is illustrated in FIG. 3 and described below in detail with reference to that figure.

In some implementations, the UE 102 may be a UE configured for a device testing user (“tester”), a device used by a tester, or a device not used by a tester. For example, a tester UE 102 may have a subscriber identity module (SIM) card (virtual or physical) configured with an emergency test parameter that the tester UE 102 may provide to the telecommunications network in place of (or in addition to the subscriber database). In further embodiments, a tester UE 102 may receive one of the alternative extended emergency number lists 114 and non-tester UEs 102 may receive a different one of the alternative extended emergency number lists 114. The tester using the tester UE 102 may then dial one number or set of numbers for testing and a different number or set of numbers for actual emergencies. A Non-tester using a non-tester UE 102 will only be aware of the numbers for actual emergencies and only use those numbers. In some examples, the testers may be associated with the telecommunications network operator and may be testing emergency number connectivity at different locations on behalf of the telecommunications network operator.

In various implementations, the telecommunications core network 104 may be a core network associated with an operator of a telecommunications network and may include nodes that connect to/communicate with UEs such as UE 102 through access networks, which may also be part of the telecommunications network. The telecommunications core network 104 may be a 4G core network, a 5G core network, a later generation core network, or any combination of features and nodes from multiple generations of core networks. As shown in FIG. 1, the telecommunications core network 104 can include the core network node 106 and subscriber database 108, in addition to other core network nodes (e.g., gateway nodes, charging nodes, etc.).

The core network node 106 may be a MME, an AMF, or a node of a later generation network having some or all of the functions of an MME or AMF. As shown herein, the core network node 106 is able to engage on non-access stratum (NAS) communications with the UE 102, such as an attach message exchange, a TAU message exchange, or a registration message exchange, to provide the UE 102 with an extended emergency number list selected by emergency number list selection module 112 of the core network node 106 from alternative extended emergency number lists 114 of the core network node 106.

In some implementations, the subscriber database 108 may be a HSS, a UDM, or a subscriber database of a later generation network having some or all of the capabilities of a HSS or a UDM. The subscriber database 108 may store profiles of multiple subscribers, including a subscriber associated with the UE 102. In 4G networks, the subscriber database 108 may store a zone code, and in 5G networks, the subscriber database 108 may store an area identifier. While the zone codes and area identifiers, may be intended for other purposes, they may be repurposed and used by the subscriber database 108 to represent an emergency test parameter, with a specific zone code or specific area identifier indicating one of the alternative extended emergency number lists 114 and other zone codes/area identifiers indicating different one(s) of the alternative extended emergency number lists 114. Alternatively, the subscriber database 108 may include an emergency test parameter expressly as a part of a subscriber profile.

In some implementations, a message from the UE 102 may begin a message exchange with the core network node 106, such as an attach message or a registration message. This message exchange may trigger further exchanges with other nodes of the telecommunications core network 104 or may be part of multiple message exchanges with multiple message nodes of the telecommunications core network. Such exchanges may be in accordance with communication/messaging flows defined by the 3GPP or may be other flows, including both those defined by standards organizations and those not defined by standards organizations. Following messages/communications associated with an attach, TAU, or registration, the core network node 106 receives, at 110 the emergency test parameter from the subscriber database 108. The subscriber database 108 may provide the test parameter as part of a larger dataset—e.g., as some or all of a subscriber profile associated with the UE 102—or may provide it on its own. As noted, the emergency test parameter may be a zone code, an area identifier, or any value representing an association with one extended emergency number list over another. The core network node 106 may receive, at 110, the emergency test parameter directly from the subscriber database 108 or through one or more other nodes of the telecommunications core network 104.

The core network node 106, upon receiving, at 110, the emergency test parameter, selects an extended emergency number list based on it. The selected, extended emergency number list may be one of the alternative extended emergency number lists 114. Such extended emergency number lists may each include one or more uniform resource names (URNs) or uniform resource identifiers (URIs) for use by UEs such as UE 102 to recognize user input as an emergency number or a test emergency number and to communicate with the telecommunications network accordingly. The alternative extended emergency number lists 114 can include multiple extended emergency number lists that are different from each other. For example, one extended emergency number list could comprise URNs that are a subset of the URNs in another extended emergency number list. In another example, two extended emergency number lists could each have different URNs from each other, either wholly or partially. The composition of the extended emergency number lists may vary, in some examples, based on the use case for the extended emergency number lists (e.g., for testing, the extended emergency number list for the non-tester UE 102 may be a subset of the extended emergency number list for the tester UE 102). The alternative extended emergency number lists 114 may be stored on the core network node 106, on a different core network node, or partially on the core network node 106 and partially on a different core network node.

In various implementations, the selection may be performed by an emergency number list selection module 112. The emergency number list selection module 112 can be implemented entirely on the core network node 106 or partially on the core network node 106 and partially on a different core network node. Upon receiving, at 110, the emergency test parameter, the emergency number list selection module 112 determines which of the alternative extended emergency number lists 114 is associated with the emergency test parameter and selects the extended emergency number list associated with the emergency test parameter.

At 116, once the emergency number list selection module 112 has selected the extended emergency number list for the UE 102, the core network node 106 provides the extended emergency number list to the UE 102. In some implementations, the core network node 106 may provide the extended emergency number list in an information element of an accept message, such as an attach accept message, a TAU accept message, or a registration accept message. The information element may be an element specifically for including an extended emergency number list. The accept message may also include a legacy, statically defined emergency number list in a different element. Such a legacy emergency number list may be used by UEs 102 that are unable to process/utilize the extended emergency number list for emergency call capabilities.

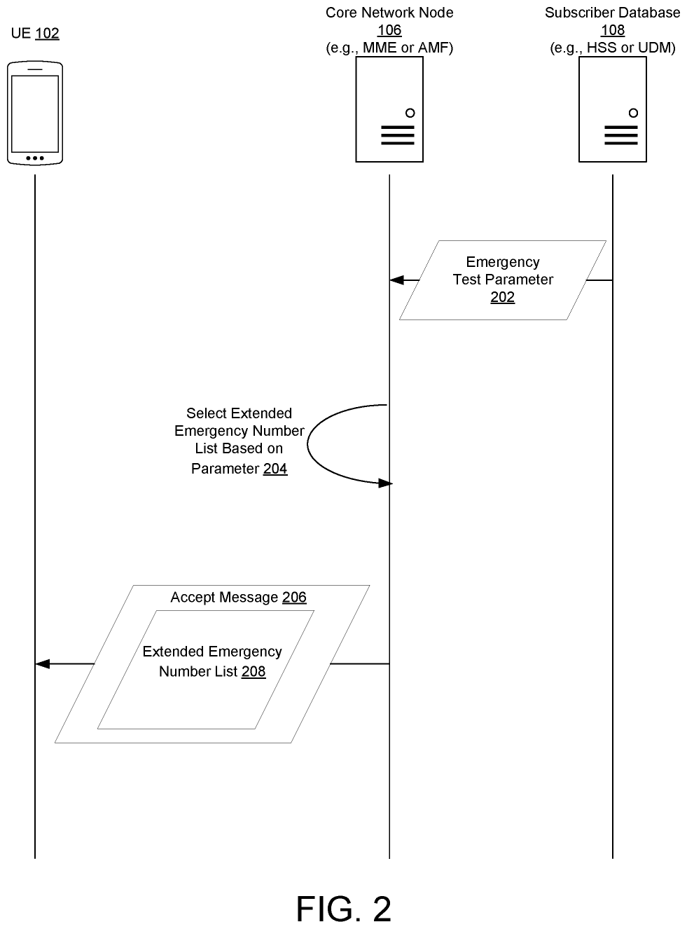

FIG. 2 is a message diagram of a message exchange between a UE and a core network node in which the UE receives an extended emergency number list in an accept response, the extended emergency number list selected for the UE by the core network node based on an emergency test parameter associated with the UE.

As shown in FIG. 2, a subscriber database 108 sends an emergency test parameter 202 to a core network node 106. As discussed herein, the emergency test parameter 202 may be communicated in a message on its own or with other aspects of a subscriber profile. Also, the message including the emergency test parameter 202 may be sent directly to the core network node 106 or indirectly through one or more other core network nodes.

At 204, the core network node 106 then selects one of multiple, alternative extended emergency number lists 114 based on the emergency test parameter. As described herein, the selecting, at 204, may be performed by an emergency number list selection module 112 and with reference to data associating ones of the multiple, alternative extended emergency number lists 114 with ones of the emergency test parameters.

In various implementations, the core network node 106 then sends the selected extended emergency number list to the UE 102 in an information element of an accept message 206 as an extended emergency number list 208. The accept message 206 may be an attach accept message, a TAU accept message, or a registration accept message and the information element may be an element of the accept message 206 reserved for an extended emergency number list such as extended emergency number list 208. The extended emergency number list 208 may include one or more URNs for use by the UE 102 in recognizing and placing emergency calls or both test emergency calls and actual emergency calls.

FIG. 3 is a schematic diagram of an example system architecture of a core network node 300 that is configured to select an extended emergency number list for a UE based on an emergency test parameter associated with the UE. The core network node 300 can be an example of the core network node 106. The core network node 300 can have at least one memory 302, processor(s) 304, one or more transceivers 306, a display 308, output devices 310, input devices 312, and/or a drive unit 314 including a machine readable medium 316. The memory 302 may include an emergency number list selection module 112, alternative extended emergency number lists 114, and other modules and data 318.

In various examples, the memory 302 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information and which can be accessed by the core network node 300. Any such non-transitory computer-readable media may be part of the core network node 300.

The memory 302 can include one or more software or firmware elements, such as computer-readable instructions that are executable by the one or more processors 304. For example, the memory 302 can store computer-executable instructions associated with emergency number list selection module 112, extended emergency number lists 114 and other modules and data 318. The emergency number list selection module 112 may select among multiple extended emergency number lists 114 based on a received emergency test parameter. The multiple extended emergency number lists 114 may each include one or more URNs. The other modules and data 318 can include a platform, operating system, and applications, and data utilized by the platform, operating system, and applications.

In various examples, the processor(s) 304 can be a CPU, a graphics processing unit (GPU), or both CPU and GPU, or any other type of processing unit. Each of the one or more processor(s) 304 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 304 may also be responsible for executing all computer applications stored in the memory 302, which can be associated with types of volatile (RAM) and/or nonvolatile (ROM) memory.

The transceivers 306 can include modems, interfaces, antennas, and/or other components that perform or assist in exchanging wireless communications, wired communications, or both.

While the core network node 300 need not include a display, output devices 310, or input devices 312, in some implementations it may include one, some, or all of these. When included, the following may apply to the display, output devices 310, or input devices 312:
The display 308 can be a liquid crystal display or any other type of display. For example, the display 308 may be a touch-sensitive display screen and can thus also act as an input device or keypad, such as for providing a soft-key keyboard, navigation buttons, or any other type of input.
The output devices 310 can include any sort of output devices known in the art, such as the display 308, speakers, a vibrating mechanism, and/or a tactile feedback mechanism. Output devices 310 can also include ports for one or more peripheral devices, such as headphones, peripheral speakers, and/or a peripheral display.
The input devices 312 can include any sort of input devices known in the art. For example, input devices 312 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 316 of a drive unit 314 can store one or more sets of instructions, such as software or firmware, that embodies any one or more of the methodologies or functions described herein. The instructions can also reside, completely or at least partially, within the memory 302, processor(s) 304, and/or transceiver(s) 306 during execution thereof by the core network node 300.

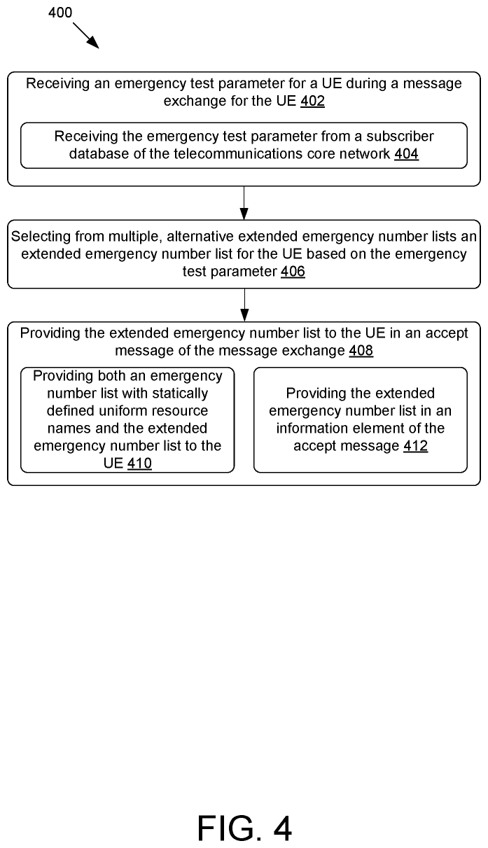

FIG. 4 illustrates an example process. This process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 4 is a flow diagram of an illustrative process 400 for selecting an extended emergency number list for a UE based on an emergency test parameter associated with the UE. At 402, a core network node of a telecommunications core network receives an emergency test parameter for a UE during a message exchange for the UE. The core network node may be a MME or an AMF. At 404, the receiving may include receiving the emergency test parameter from a subscriber database of the telecommunications core network. The subscriber database may be a HSS or a UDM node. In some implementations, the emergency test parameter may be a zone code or an area identifier.

At 406, the core network node selects from multiple, alternative extended emergency number lists an extended emergency number list for the UE based on the emergency test parameter.

At 408, the core network node provides the extended emergency number list to the UE in an accept message of the message exchange. The accept message may be an attach accept message, a TAU accept message, or a registration accept message. At 410, the providing may include providing both an emergency number list with statically defined uniform resource names and the extended emergency number list to the UE. At 412, the providing may comprise providing the extended emergency number list in an information element of the accept message.

In various implementations, the UE may be a tester UE and the extended emergency number list may include both a tester URN and a URN used for non-test emergencies by both tester UEs and non-tester UEs. Also, the multiple, alternative extended emergency number lists may include the extended emergency number list and an alternate extended emergency number list. The alternate extended emergency number list in turn may include a subset of the URNs in the extended emergency number list or different URNs than the URNs in the extended emergency number list.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
receiving, by a core network node of a telecommunications core network, during a message exchange for a user equipment (UE), an emergency test parameter for the UE;
selecting, by the core network node, from multiple, alternative extended emergency number lists an extended emergency number list for the UE based on the emergency test parameter; and
providing, by the core network node, the extended emergency number list to the UE in an accept message of the message exchange.

2. The method of claim 1, wherein the receiving comprises receiving the emergency test parameter from a subscriber database of the telecommunications core network.

3. The method of claim 2, wherein the core network node is a mobility management entity (MME), the subscriber database is a home subscriber server (HSS), and the accept message is an attach accept message or a tracking area update accept message.

4. The method of claim 2, wherein the core network node is an access and mobility management function (AMF), the subscriber database is a unified data management (UDM) node, and the accept message is a registration accept message.

5. The method of claim 1, wherein the emergency test parameter is a zone code or an area identifier.

6. The method of claim 1, wherein the providing comprises providing both an emergency number list with statically defined uniform resource names and the extended emergency number list to the UE.

7. The method of claim 1, wherein the providing comprises providing the extended emergency number list in an information element of the accept message.

8. The method of claim 1, wherein the UE is a tester UE and the extended emergency number list includes both a tester uniform resource name (URN) and a URN used for non-test emergencies by both tester UEs and non-tester UEs.

9. The method of claim 1, wherein the multiple, alternative extended emergency number lists include the extended emergency number list and an alternate extended emergency number list, wherein the alternate extended emergency number list includes a subset of uniform resource names (URNs) in the extended emergency number list or different URNs than the URNs in the extended emergency number list.

10. A core network node of a telecommunications core network, the core network node comprising:
a processor; and
a plurality of programming instructions configured to be operated by the processor to perform operations including:
receiving, during a message exchange for a user equipment (UE), an emergency test parameter for the UE;
selecting from multiple, alternative extended emergency number lists an extended emergency number list for the UE based on the emergency test parameter; and
providing the extended emergency number list to the UE in an accept message of the message exchange.

11. The core network node of claim 10, wherein the receiving comprises receiving the emergency test parameter from a subscriber database of the telecommunications core network.

12. The core network node of claim 11, wherein:
the core network node is a mobility management entity (MME), the subscriber database is a home subscriber server (HSS), and the accept message is an attach accept message or a tracking area update accept message, or
the core network node is an access and mobility management function (AMF), the subscriber database is a unified data management (UDM) node, and the accept message is a registration accept message.

13. The core network node of claim 10, wherein the emergency test parameter is a zone code or an area identifier.

14. The core network node of claim 10, wherein the providing comprises providing both an emergency number list with statically defined uniform resource names and the extended emergency number list to the UE.

15. The core network node of claim 10, wherein the UE is a tester UE and the extended emergency number list includes both a tester uniform resource name (URN) and a URN used for non-test emergencies by both tester UEs and non-tester UEs.

16. The core network node of claim 10, wherein the multiple, alternative extended emergency number lists include the extended emergency number list and an alternate extended emergency number list, wherein the alternate extended emergency number list includes a subset of uniform resource names (URNs) in the extended emergency number list or different URNs than the URNs in the extended emergency number list.

17. A non-transitory computer storage medium having a plurality of programming instructions stored thereon that, when executed by a core network node of a telecommunications core network, cause the core network node to perform operations comprising:
receiving, during a message exchange for a user equipment (UE), an emergency test parameter for the UE;
selecting from multiple, alternative extended emergency number lists an extended emergency number list for the UE based on the emergency test parameter; and
providing the extended emergency number list to the UE in an accept message of the message exchange.

18. The non-transitory computer storage medium of claim 17, wherein the receiving comprises receiving the emergency test parameter from a subscriber database of the telecommunications core network.

19. The non-transitory computer storage medium of claim 17, wherein the emergency test parameter is a zone code or an area identifier.

20. The non-transitory computer storage medium of claim 17, wherein the UE is a tester UE and the extended emergency number list includes both a tester uniform resource name (URN) and a URN used for non-test emergencies by both tester UEs and non-tester UEs.
